(19) United States
(12) Patent Application Publication
(10) Pub. No.: US 2017/0342957 A1
(43) Pub. Date: Nov. 30, 2017

(54) SUPPORT STRUCTURE FOR TIDAL ENERGY CONVERTER SYSTEM

(71) Applicant: Energy Technologies Institute LLP, Loughborough, Leicestershire (GB)

(72) Inventors: Andy Baldock, Loughborough (GB); Robert Rankin, Loughborough (GB); Andy Jones, Loughborough (GB); Ian Wilson, Loughborough (GB); Holly Bower, Loughborough (GB); Timothy William Baker, Loughborough (GB); Daniel Matson, Loughborough (GB); Claire Legrand, Loughborough (GB); Aruna Seneviratne, Loughborough (GB); Joe Fison, Loughborough (GB); Dave Rigg, Loughborough (GB); Simon Chapman, Loughborough (GB); Richard Clark, Loughborough (GB); Nancy Wasson, Loughborough (GB); Richard Parkinson, Loughborough (GB); Claire Cohen, Loughborough (GB)

(73) Assignee: Energy Technologies Institute LLP, Loughborough, Leicestershire (GB)

(21) Appl. No.: 15/318,657

(22) PCT Filed: Jun. 11, 2015
(86) PCT No.: PCT/GB2015/051717

§ 371 Date: Dec. 13, 2016

(30) Foreign Application Priority Data
Jul. 2, 2014 (GB) 1411872.3

(51) Int. Cl. F03B 13/26; F03B 13/10; F03B 17/06

(52) U.S. Cl. CPC F03B 13/264; F03B 13/10; F03B 17/061; F05B 2240/97; F05B 2240/95

(57) ABSTRACT

The present invention generally relates to a support structure for Tidal Energy Converters (TECs), the support structure being for completely submerged deployment. A preferred support structure includes a single stanchion 4, extending in a first direction, and a cross arm 5, extending in a second direction perpendicular or substantially perpendicular to the first direction. The cross arm 5 is statically attached to the stanchion 4, and can support a plurality of TECs 3. A support structure also includes a support frame 7, which extends further in a third direction, perpendicular or substantially perpendicular to the first and second directions, than in the second direction. The support frame 7 is operable to anchor the support structure to a seabed.

### FIELD OF DISCLOSURE

The present invention relates to Tidal Energy Converter Systems for deployment on the seabed.

### BACKGROUND

Energy produced by the tide can be harnessed in many different ways. One method of harnessing tidal energy is a tidal barrage, which allows water to flow past a turbine and into a reservoir during high tide. The turbine converts the energy from the flow of water into electricity. The release of that water, again past the turbine, from the reservoir can be controlled during low tide for further electricity generation.

Another method to extract energy from a tide is a tidal stream generator, in which water is not stored in a reservoir but is instead allowed to naturally move with the tide. A tidal stream generator may also be termed a Tidal Energy Converter, or TEC. In one variant of a TEC, defined as a horizontal axis turbine, a structure similar to a wind turbine can extract energy from a free stream of water (i.e. water that is naturally free flowing), and may be submerged in water. Such an arrangement may include blades attached to a generator. The higher viscosity and density of water compared to air, however, requires some design consideration meaning that a wind turbine cannot simply be placed underwater.

To relay the generated electricity to land, one or more TECs may be attached to a subsea (or above sea) hub to which electrical power outputs of the generators are connected. An example of such a hub includes the Undersea Substation Pod™ by Ocean Power Technologies http://www.oceanpowertechnologies.com/pod.html, and in U.S. Pat. No. 7,989,984, or the WaveHub™ described at http://www.wavehub.co.uk.

The TEC may be mounted on a support structure, or may be buoyant and tethered to a seabed or a riverbed. If a support structure is used, it must be able to withstand the forces associated with the flow of water, which may be greater than those associated with the flow of air. Similarly, if the TEC variants use blades to power generators, those blades may also need to be able to withstand a greater load than blades on a wind turbine.

If deployed in the sea, the components of the TEC and the support structure must be either made from materials that are unaffected by salt water, or protected from it. If the structure is weakened by corrosion, the imposed rotor and environmental loads may be sufficiently large to damage the support structure. Additionally, a TEC may include mechanical components with moveable parts whose operation may be affected by corrosion, such as a gearbox.

Installation and maintenance of the TEC and support structure must also be considered during design. For deployment on a seabed, the very nature of TECs means they are deployed in a dynamic sea environment and can be submerged many metres under water and can therefore experience significant (albeit temporary) loads during installation phases. Additionally, opportunities to undertake inspection activities are generally constrained by the weather and sea conditions.

To carry out installation, maintenance and inspection activities for the support structure, one or more divers may be required. Alternatively, TECs may be installed remotely with the use of Remote Operating Vehicles (ROVs). The safety of any operatives onboard surface vessels, and of any divers, must be given a high priority when designing an underwater TEC system. Furthermore, due to the sensitivity of the installation activities, to deploy a TEC system on the seabed there may be a higher risk of damage if as the sea and weather conditions become more aggressive (for example, if the sea swell reaches 5 or higher on the Douglas Sea Scale). Prolonged exposure to such conditions increases the risk of the installation activities being aborted and possible damage to the structure and/or vessel the later thereby increasing the risk to onboard operatives.

In addition, hydrodynamic drag loads imposed on large support structures can have an adverse influence on the energy extraction capabilities of the TEC systems which can greatly diminish the commercial viability of a project. These issues are further amplified in deeper waters where a significant proportion of available tidal energy is located and remains untapped.

Conventional single pile support structures (i.e. monopile), such as those used in rivers or estuaries, become less suitable in deeper waters as structural (strength, stiffness and fatigue) limits are approached due to large rotor loads, increased hydrodynamic loads and escalating bending moments (function of lever arm). Moreso, conventional single pile support structures have multiple lines of symmetry, which is structurally inefficient at most tidal sites where the dominant loading is bi-directional as a function of the tidal flow.

A tripod or quadrapod foundation can be used in place of the monopile but the drilling of three or more piles per structure is expensive whilst the larger foundation increases drag of the structure which in turn requires a more robust, often larger, foundation. The large frontal area of such a foundation has a pronounced adverse impact on useful energy extraction, particularly when considering an array of TECs.

U.S. Pat. No. 7,215,036 describes a structure in which multiple current generators are mounted on a support frame consisting of horizontal members and vertical members. For example, four current generators may be mounted on a support frame consisting of two horizontal members and one vertical member. The arrangement of U.S. Pat. No. 7,215,036 does not readily allow for ease of removal and replacement, or maintenance of a single current generator.

In WO2004/048774, at least one turbine unit is mounted on a support structure. An important feature of WO2004/048774 is that the one or more turbines can be raised out of the water, whilst still connected to the (raised) support structure, for ease of access during installation, maintenance and repairs. Such an arrangement is impractical in deep water, such as on a seabed, due to the distance that the one or more turbines must be raised. The additional moving parts required to raise and lower the one or more turbines whilst still connected to the support structure, will also complicate the structure.

An arrangement in which a plurality of turbines is mounted on a platform, which can be raised to bring the turbines out of the water for installation, maintenance and repairs, is considered in GB2400414. Similarly to WO2004/048774, raising the turbines out of the water whilst still connected to the (raised) support structure for installation, maintenance and repairs is impractical when a TEC system is deployed in deep water.

In light of the above problems, there is a need for a TEC system that can be deployed for prolonged periods of time to harness the energy in the tidal flows proximate the seabed. Such tidal flows represent a largely un-tapped source of renewable energy. Due to the harsh environment in which the TEC systems are to be located, and the potential difficulties in accessing the location, the amount of maintenance required is to be kept to a minimum, whilst not significantly affecting efficiency.

### Means for Solving the Problem

The present invention generally includes a support structure, fixable to the seabed, that provides the platform on which to mount at least two Tidal Energy Converters, TECs, (e.g. turbine units). This ensures the TECs are kept on position once deployed and allows the required movement of the TECs to extract energy from the varying flow directions. The invention also relates to a bipedal support frame for a TEC support structure and an array of TEC systems.

In accordance with the present invention, there are provided support structures in accordance with claims 1 and 12, a TEC system in accordance with claim 17, and a TEC array in accordance with claim 18. Other aspects of the present invention are set out in the dependent claims.

A support structure for Tidal Energy Converters according to the present invention is for completely submerged deployment and comprises a single stanchion, a cross arm and a support frame. The stanchion extends in a first direction. The cross arm extends in a second direction perpendicular or substantially perpendicular to the first direction, is statically attached to the stanchion and is operable to support a plurality of Tidal Energy Converters. The support frame extends further in a third direction, perpendicular or substantially perpendicular to the first and second directions, than in the second direction, is attached to the stanchion and is operable to anchor the support structure to a seabed. For example, the first direction may be generally vertical, the second direction may be horizontal and perpendicular to the upstream/downstream direction of tidal flow, and the third direction may be along the upstream/downstream direction of tidal flow.

A support structure of the present invention is able to be deployed for prolonged periods of time, with minimal repair and maintenance requirements, on the seabed. Advantageously, this allows energy from largely untapped deep tidal flows to be exploited for electricity generation. Having the support frame extend in a direction perpendicular or substantially perpendicular to the direction of the cross arm provides a generally streamlined shape for the support structure, thereby reducing the load imposed on the support structure by the tidal flow.

In certain aspects, at least part of the length of the stanchion has a streamlined cross section, the streamlined cross section extending further in the third direction than in the second direction. This further reduces the imposed load caused by tidal flow on the support structure. In one aspect, the lengths of the streamlined cross section of the stanchion in the third direction and in the second direction have a ratio of between 1.5:1 and 5:1. Alternatively, the stanchion can have a circular cross section. A stanchion with a circular cross section is simpler to manufacture, and provides improved structural strength against forces having a component perpendicular to the main tidal flow.

In some aspects, the support structure comprises two or more struts attached to and extending from the stanchion and attached to the cross arm. This provides additional support and rigidity for the cross arm and can serve to dampen vibrations in the cross arm.

In some aspects, the cross arm has a streamlined cross section, which is longer in the third direction than in the first direction.

In some aspects, the stanchion and support frame form a streamlined support apparatus. Such an apparatus reduces the hydrodynamic load imposed on the support structure as a whole.

Another aspect of the present invention relates to a support structure comprising a bipedal support frame. The support frame comprises two anchors for use in attaching the support structure to a seabed. Using a bipedal support frame in an area of bi-directional fluid flow improves structural and manufacturing efficiency by avoiding less necessary anchors without compromising the stability of the support structure. Further, a bipedal arrangement means the support structure as a whole is generally streamlined, thereby reducing the hydrodynamic load imposed on the support structure by the tidal flow.

The anchors may comprise a sleeve for coupling to a pile embedded in the seabed, or may comprise a pile for coupling to a sleeve embedded in the seabed.

In some aspects, the attachment means comprise one or more struts being operable to attach the anchor to the stanchion. Preferably, one or more of the struts attaching an anchor to the stanchion extends from the anchor at between 0° and 90° above horizontal. The struts may have a circular cross section.

A support structure of the present invention may incorporate such a bipedal support frame. In some aspects, the bipedal support frame is adapted to maintain the stanchion raised above the seabed. As it is unnecessary for the stanchion to extend to the seabed, manufacturing may be more efficient in terms of materials.

Other aspects of the present invention relate to a Tidal Energy Converter System comprising a support structure.

A further aspect of the present invention relates to a Tidal Energy Converter array mounted on the seabed comprising a plurality of support structures which include a single stanchion, extending in a first direction, and a cross arm, extending in a second direction perpendicular or substantially perpendicular to the first direction. The cross arm is statically attached to the stanchion. Further, the support structures each have a streamlined component extending further in a third direction, perpendicular or substantially perpendicular to the first and second directions, than in a second direction. The support structures are disposed in an arrangement with regular spacing between support structures in the second direction. With the support structure having a streamlined component, the energy extracted from the tidal flow by the support structure, not the Tidal Energy Converters themselves, is minimised, thereby increasing the percentage of energy extracted from the tidal flow. Further, the disruption of the tidal flow for downstream rigid support structure will be reduced, thereby also improving the increasing the percentage of energy extracted from the tidal flow.

Various embodiments and aspects of the present invention are described without limitation below, with reference to the accompanying figures.

### BRIEF DESCRIPTION OF THE DRAWINGS

FIG. 1 shows a perspective view of a TEC system.

FIG. 2 shows a perspective view of a TEC support structure.

FIG. 3 shows a rear view of a TEC system.

FIGS. 4a-c show examples of streamlined cross sectional shapes for a TEC support structure or a cross arm.

FIG. 5 shows a plan view of a TEC support structure.

FIG. 6 shows a support frame for a TEC support structure viewed perpendicular to the direction of tidal flow.

FIG. 7 shows a plan view of an array of TEC systems in which a row is offset from the preceding row.

FIG. 8 shows a plan view of an array of TEC systems in which the TEC systems are disposed on a rectangular grid.

### DETAILED DESCRIPTION

A Tidal Energy Converter (TEC) system 1 according to an embodiment of the present invention comprises a support structure 14 for TECs and a plurality of TECs. The support structure 14 comprises a single stanchion 4 extending in a first direction and a cross arm 5 for supporting two TECs 3, the cross arm 5 extending in a second direction perpendicular, or substantially perpendicular, to the first direction. The support structure 14 further includes a support frame 7 extending further in a third direction than the second direction, wherein the third direction is perpendicular, or substantially perpendicular, to the first and second directions. The present embodiment relates to TEC systems designed for completely submerged deployment in deep water (for example, a depth of greater than approximately 30 m), whilst minimising the amount of maintenance required. It is to be noted, however, that the TEC systems described herein can be submerged in shallower waters and still used to advantageous effect.

### Array

TEC systems 1 may be deployed in an array in order to capitalise on the energy in a tidal flow area. Each of the TEC systems 1 is mounted on the seabed. Accordingly, the array does not need to extend as far in the first direction (substantially vertically) from the seabed, thereby minimising the impact on water flow in the tidal flow area. In general, the support structures 14 for the TEC systems 1 included in the array have a streamlined component, which extends further in the third direction (along the flow of water) than in the second direction (perpendicular to the flow of water). Further, the support structures 14 are generally disposed in an array arrangement with regular spacing between support structures 14 in the second direction. A streamlined component may be a support apparatus 2, a stanchion 4, a cross arm 5, a support frame 7, or any combination of these.

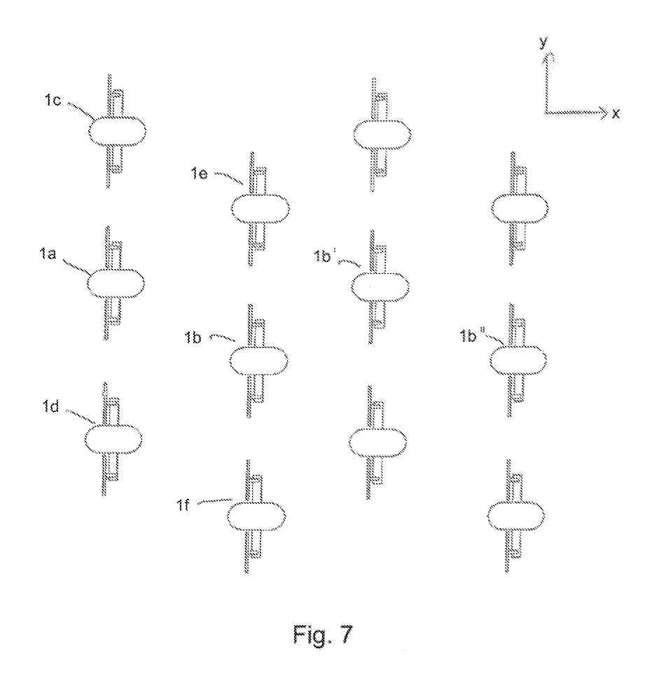

FIG. 7 shows an example of an array, which comprises a plurality of rows of TEC systems 1 orientated in the y-direction, whilst the flow of water would be in the x-direction. The TEC systems 1 within a row are regularly spaced. For example, FIG. 7 shows each of the TEC systems 1a, 1c, 1d in the first row are regularly spaced, and the TEC systems 1b, 1e, 1f in the second row are regularly spaced. The TEC systems 1b, 1e, 1f in the second row, as shown in FIG. 7, may be offset, or staggered, from the TEC systems 1a, 1c, 1d in the first row.

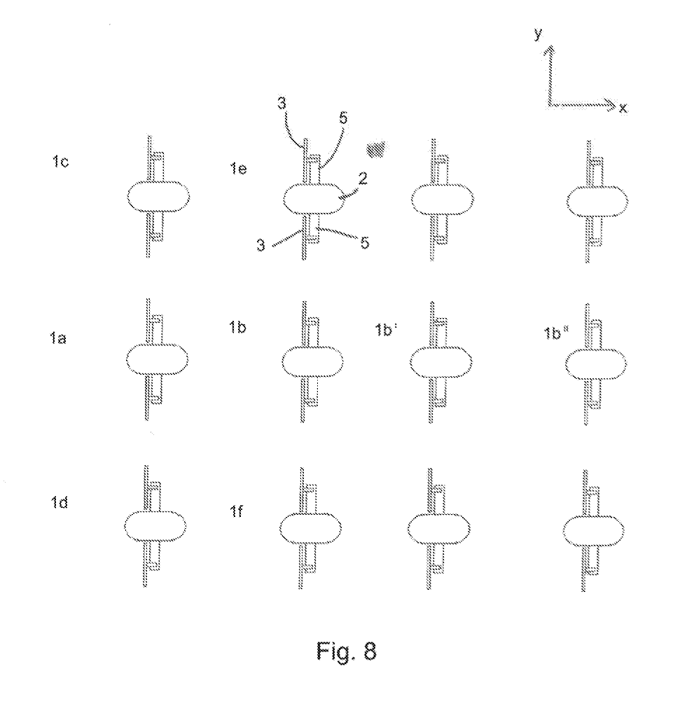

Alternatively, as shown in FIG. 8, the TEC systems 1b, 1e, 1f of the second row may be aligned with the TEC systems 1a, 1c, 1d of the first row. In this arrangement, the TEC systems 1, 1a, 1b, 1b′, 1b″, 1c, 1d, 1e, 1f in the array are positioned in columns and rows so as to be disposed on a rectangular grid. The rectangular grid refers to a grid of any regular quadrilateral and so may include a square.

For ease of understanding the array, the TEC systems 1, 1a, 1b, 1b′, 1b″, 1c, 1d, 1e, 1f in FIGS. 7 and 8 are shown as a generally streamlined support apparatus 2 with an attached cross arm 5 supporting two TECs 3. The generally streamlined support apparatus 2 includes a stanchion 4 and a support frame 7. The array may, however, generally comprise a plurality of TEC systems 1 having a streamlined component (such as the support apparatus 2, the stanchion 4, the cross arm 5, the support frame 7, or any combination of these) disposed with a second row of regularly spaced TEC systems offset from a first row of regularly spaced TEC systems (for example, FIG. 7), or with the TEC systems in a rectangular grid (for example, FIG. 8).

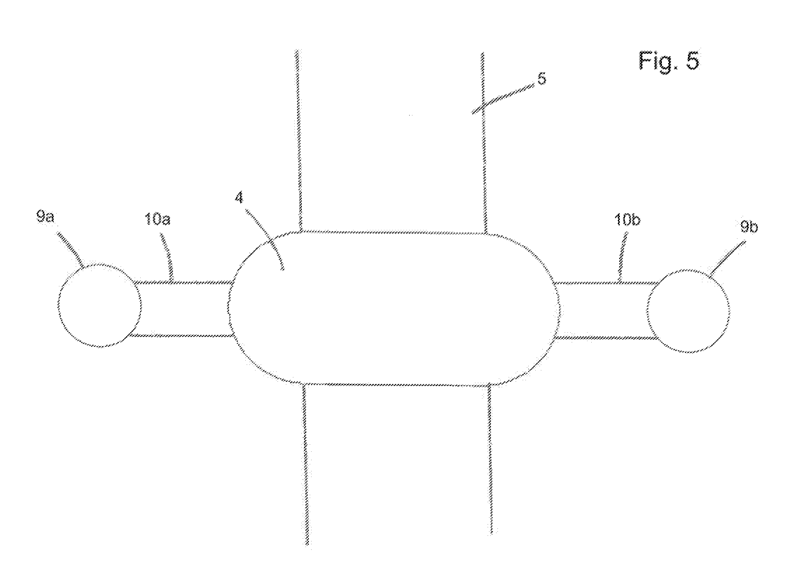

With reference now to FIG. 5, the support apparatus 2 includes the stanchion 4, the support frame 7 and the struts 10a, 10b. When viewed from above, as in FIG. 5, each support apparatus 2 (i.e. a TEC system 1, but not including the cross arm 5 and TECs 3) extends further in the third direction (such as the x-direction in FIGS. 7 and 8) than in the second direction (such as the y-direction in FIGS. 7 and 8) perpendicular to the third direction. The support apparatus 2, as a combined entity, of the TEC system 1 is therefore streamlined. The individual components of the support apparatus 2 may also be streamlined.

A streamlined support apparatus 2 for the TEC systems 1 reduces the amount of energy extracted from the tidal flow by the TEC support apparatus 2 and not converted to electricity by the generator portion. Put another way, the streamlined support apparatus 2 allows the TEC system 1 to maximise the ‘useful’ energy extraction from the fluid flow.

Whilst the streamlined support apparatus 2 for the TEC systems 1 is advantageous for each individual TEC system 1, the advantageous effect in an array of TEC systems 1 is greater still. The streamlined support apparatus 2 reduces the turbulence caused by one TEC system 1a, thereby reducing the adverse effects of such turbulence on the downstream TEC systems 1b, 1b′, 1b″, 1e, 1f. Additionally, wake effects are reduced in relation to neighbouring TEC systems 1c, 1d that are not downstream of the one TEC system 1a.

When the array of TEC systems 1 is considered as a whole, the efficiency saving, in terms of useful energy extracted from the tidal flow, related to each of the TEC systems 1 having a streamlined support apparatus 2 is amplified. If conventional TEC systems, without a streamlined component, were disposed in a rectangular grid, the wake and hydrodynamic effects caused by one TEC system would severely reduce the efficiency of energy extraction for the TEC systems downstream of that one TEC system. The preferred array of TEC systems 1 having a streamlined component therefore extracts energy from the tidal flow in an efficient manner, thereby reducing the number of TEC systems 1 required in the array to extract a given amount of energy.

### TEC System

A TEC system 1 may comprise a support structure 14, which includes a support apparatus 2 and a cross arm 5, with a plurality of TECs 3 attached to the cross arm 5. The support apparatus 2 includes at least a single stanchion (or vertical support member) 4, and a support frame 7 attached to that stanchion 4. The cross arm 5 is operable to support a plurality of Tidal Energy Converters (TECs) 3.

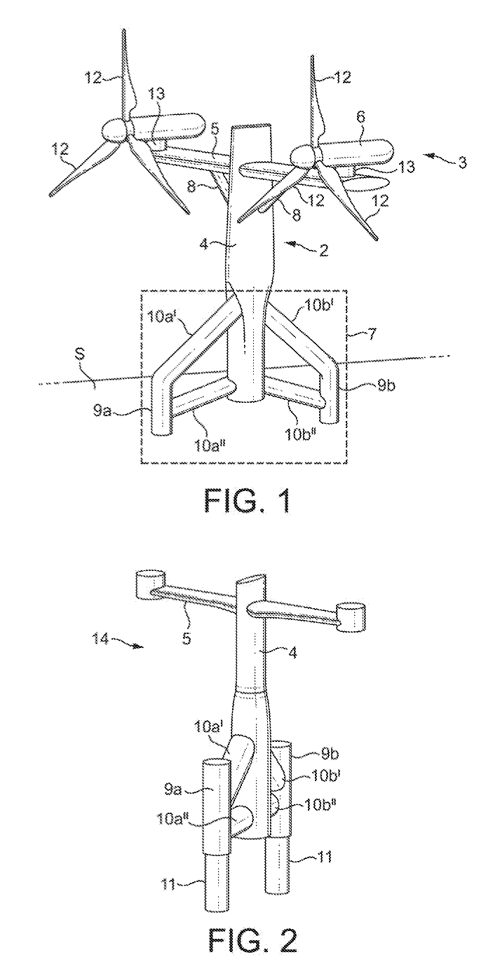

A TEC support structure 14 shown in FIGS. 1-3 comprises a stanchion 4 and a cross arm 5 for supporting at least two TECs 3. The TEC support structure 14 is preferably streamlined, at least in part, to reduce the imposed hydrodynamic loads on the TEC system 1, to minimise structural requirements, and to maximise the ‘useful’ energy extraction from the fluid flow.

In a preferred TEC system 1, the TEC support structure 14 supports two TECs 3, with one TEC 3 at either end of a horizontal or substantially horizontal cross arm 5 that is statically (or ‘rigidly’) fixed toward an upper end of a stanchion 4 to form a ‘T’ shaped structure. In some aspects, the cross arm 5 may be fixed at the top of the stanchion 4. In some aspects, the cross arm 5 is horizontal or substantially horizontal. In some aspects, the cross arm 5 is attached to the stanchion 4 in the centre, or substantially in the centre, of the length of the cross arm 5. The stanchion 4 may therefore be termed a central stanchion.

In the preferred embodiment, the TEC support structure 14 is a rigid, subsea structure such that the TEC support structure 14 is kept in position once deployed. The TECs 3 are similarly held in position during operation, but may be removed for maintenance. It is not necessary, however, to move any part of the TEC support structure 14 during maintenance of the TECs 3. This creates a more robust structure. The stanchion 4 may be kept in position once deployed. The cross arm 5 is held statically in relation to the stanchion 4, thereby minimising the number of potential points of failure, reducing the amount of maintenance required and providing a more robust support structure 14.

It is preferred that the structure 14 is made from steel (for example, stainless steel), although it will be apparent to the skilled person that the structure 14 can be made from other materials without departing from the present invention. For example, the support structure 14 may be made from concrete or a composite material.

The lower end of the TEC support structure 14 is held static relative to the seabed by a support frame 7. The support frame 7 is preferably bipedal and comprises two anchors (or anchoring means) located on opposite sides of the stanchion 4 in an upstream/downstream direction (i.e. arranged along the third direction).

The generator portion of the preferred embodiment comprises two TECs 3—one located at either end of the cross arm 5. The TECs 3 are mounted to the cross arm 5. In the preferred embodiment, a yaw drive system (YDS) 13 may be included to direct the TECs 3 to point into the tidal flow. The YDS 13 in the preferred embodiment may be of any type. For example the YDS 13 may be of a driven, non-driven, vertical axis, horizontal axis, etc type. A TEC 3 in the preferred arrangement comprises a generator coupled to a hub, which can be rotated by a number of blades as fluid flows over the blades. The pitch of the blades may also be changeable. In some embodiments, the pitch of the blades 12 may be changed by at least 180 degrees, thereby allowing the blades to face the tidal flow without needing a YDS. Adjusting the pitch of the blades 12 by at least 180 degrees is disclosed in WO02066828, to Hammerfest Stroem AS. WO02066828 is hereby incorporated by reference in its entirety.

### Stanchion

In the preferred embodiment, a single stanchion (vertical support member) 4 is provided to support two TECs 3. This improves structural efficiency and minimises the cost of the TEC support apparatus 2 per TEC.

The stanchion 4, in the preferred embodiment, is at least in part formed to have a streamlined cross section so as to limit the hydrodynamic forces imparted on the stanchion 4. The diameter of the streamlined cross section in a lengthwise direction (for example, the third direction) is larger than the diameter in a direction perpendicular to the lengthwise direction (for example, the second direction). In other words, the cross sectional shape is longer than it is wide. The cross sectional shape narrows toward each opposed end in the lengthwise direction. In some embodiments, the cross sectional shape narrows continuously, whereas in other embodiments the cross sectional shape narrows in a step-wise manner. In certain embodiments, the ratio of the length of the cross sectional shape to the width of the cross sectional shape is in the range 1.5-5:1 in the preferred embodiment (for example, 2:1). Other ratios can be used depending on, for example, the site at which the TEC support apparatus 2 is located.

Preferably, the streamlined cross section has two axes of symmetry, one along the length and one along the width. The streamlined cross section has the same drag coefficient for a fluid moving in one direction past the stanchion 4 and moving in the opposite direction past the stanchion 4.

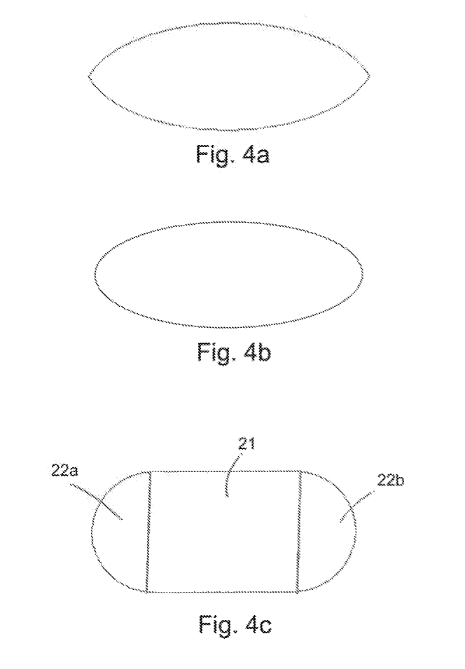

Examples of suitable cross sectional shapes are shown in FIGS. 4a-c and include an ellipse, an oval, or two parabolas enclosing a space.

The present invention is particularly advantageous in a tidal area where a large portion of the force that acts on the TEC support apparatus 2 is bi-directional—when the tide is coming in the force majoritively acts in one direction, and when the tide going out the force majoritively acts in another direction opposed to the one direction. The TEC support apparatus 2 can be deployed such that the lengthwise direction of the cross sectional area is arranged parallel or substantially parallel to the upstream/downstream direction of tidal flow.

With the lengthwise direction orientated along the upstream/downstream direction of tidal flow (for example, the third direction), there is a reduced need for rigidity in the direction perpendicular to the lengthwise direction (for example, the second direction). The width of the stanchion 4 can be reduced in comparison to a conventional tubular support, which has a circular cross section. Accordingly, the amount of material required to manufacture a TEC support apparatus 2 that is rigid enough to withstand the force of a tidal flow can be reduced. Reducing the width of the stanchion 4 also reduces the area drag, thereby creating a more streamlined arrangement. The TEC support apparatus 2 is therefore stronger and more rigid in a direction opposing the majority of the force of tidal flow than in a direction perpendicular to the tidal flow.

Further advantages of a streamlined TEC support apparatus 2 arise when an array of TEC systems 1, each incorporating the TEC support apparatus 2, are deployed. The flow of water past a streamlined TEC support apparatus 2 will be disrupted less than the flow of water past a conventional support apparatus. For example, the streamlined TEC support apparatus 2 will produce less wake. Accordingly, the flow of water is more uniform for TEC systems 1 proximate the streamlined TEC support apparatus 2. The flow of water is therefore more predictable and turbulence caused by one TEC system 1 is less likely to adversely affect other TEC systems 1.

Depending on manufacturing constraints, the stanchion may be comprised of a series of ‘cans’, or portions, that are connected to form the stanchion.

### Cross-Arm

As shown in FIGS. 1-3 and 5, a cross arm 5 is attached substantially horizontally across the stanchion 4 so as to form a ‘T’ shape. When the stanchion 4 includes a portion having a streamlined cross section, the cross arm 5 extends in a direction (for example, the second direction) perpendicular to the lengthwise direction of that streamlined cross section (for example, the third direction). When the TEC support structure 14 is deployed, the cross arm 5 extends in a direction transverse to the tidal flow.

The cross arm 5 can be attached to the top, or near to the top, of the stanchion 4. A TEC nacelle 6 can be attached to or near to each end of the cross arm 5, such that each TEC system 1 includes two TEC nacelles 6. Including two TECs 3 for each TEC support apparatus 2 in this manner provides a balance between structural complexity and installation efficiency. Additionally, the mechanical load on the TEC support system 1 is evenly balanced during operation.

With a seabed deployment, which may have a depth greater than 30 m (for example, 45 m or 60 m in depth), it is impractical to provide a specific lifting mechanism arrangement that elevates the TECs 3 above the surface of the water for maintenance, replacement etc without changing the position of the TEC support structure 14. Further, such an arrangement requires additional mechanical parts, which introduce additional points of failure. Once attached, the cross arm 5 is held in place in relation to the stanchion 4. In other words, the cross arm 5 is statically attached to the stanchion 4. With the cross arm 5 statically attached to the stanchion 4 in this manner, the support structure 14 may be termed a static support structure 14.

The cross section of the cross arm 5, in the preferred embodiment, is streamlined in a similar manner to the stanchion 4. Particularly, the diameter of the cross section of the cross arm 5 in a lengthwise direction (for example, the third direction when the cross arm 5 is fixed to a stanchion 4) is larger than the diameter of in a direction perpendicular to the lengthwise direction (for example, the first direction when the cross arm 5 is fixed to a stanchion 4). In other words, the cross sectional shape of the cross arm 5 is longer than it is wide. The cross sectional shape narrows toward each opposed end in the lengthwise direction. In some embodiments, the cross sectional shape narrows continuously, whereas in other embodiments the cross sectional shape narrows in a step-wise manner.

In the preferred embodiment, the ratio of the length of the cross sectional shape to the width of the cross sectional shape of the cross arm 5 is in the range 1.5-5:1 in the preferred embodiment (for example, 2:1) for example, 3:1. Other ratios will still provide an advantageous effect.

As noted with the stanchion 4, possible cross sectional shapes for the cross arm 5 include an ellipse, an oval, two parabolas enclosing a space, or a rectangular section with a semi-circular portion on two opposed ends, where the semi-circular portion has a diameter equal to the width of the rectangular section.

Support struts 8 can be attached between the stanchion 4 and the cross arm 5 to improve the rigidity of the TEC system 1 by countering the moment created by the TEC 3 attached to the cross arm 5. The support struts 8 may also provide stability to the cross arm 5. For example, vibrations in the cross arm 5 will be dampened by the support struts 8.

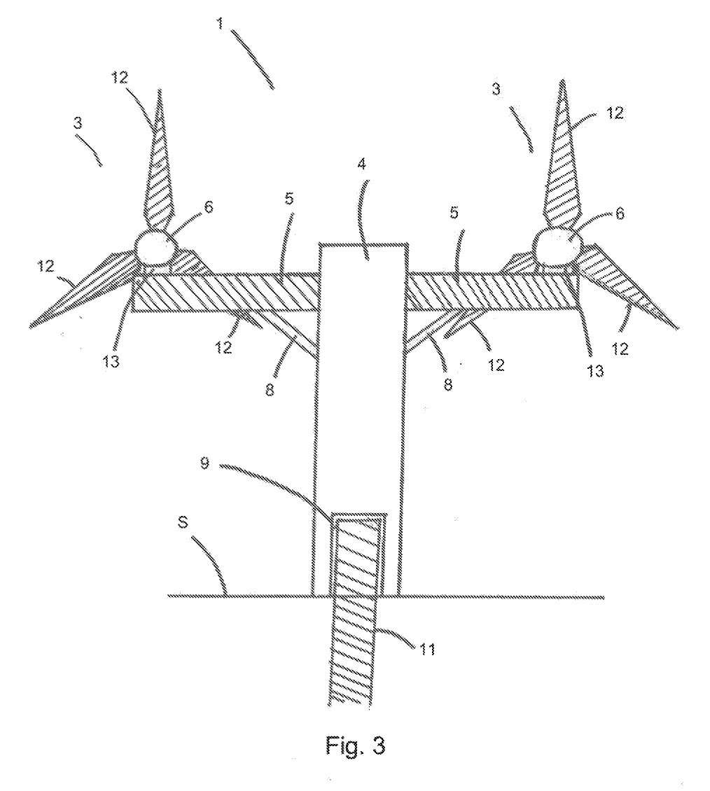

A support strut 8 may extend from a point on the stanchion 4 below the cross arm 5 to a point on the cross arm 5, as shown in FIG. 3. If the stanchion 4 extends above the cross arm 5 (i.e. the cross arm 5 is not attached to the very top of the stanchion 4), supporting struts may extend from a point on the stanchion 4 above the cross arm 5 to a point on the cross arm 5.

The support struts 8 may have a streamlined cross section in a similar manner to the stanchion 4 and the cross arm 5. It is to be noted that the stanchion 4, the cross arm 5 and the struts 8 may each have a different streamlined cross section. In some embodiments, the support struts 8 may have a simple tubular cross section for ease of manufacturing.

In some embodiments, the cross arm 5 can support more than two TECs 3. For example, one TEC 3 can be mounted at either end of the cross arm 5, with a further TEC 3 mounted in the middle (at or near the connection of the cross arm 5 to the stanchion 4). The further TEC 3 may be mounted on the stanchion 4 itself, rather than on the cross arm 5. Such an arrangement has the advantage of requiring fewer TEC support structures 14 per TEC 3, but increases the complexity of the TEC system 1 both in terms of manufacturing, maintenance, and replacement of TECs 3.

### Support Frame

A TEC system 1 according to the present invention is preferably anchored to the seabed S by a support frame 7, with the stanchion 4 extending vertically away from the seabed S and the TEC nacelles 6, and cross arm 5, located toward an end of the stanchion 4 remote from the seabed S. The support frame 7 disclosed herein is not limited to supporting TEC systems 1 of the preferred embodiment, and may be used to support other TEC systems in a bi-directional tidal flow area.

As shown in FIGS. 1-2, 5 and 6, in the preferred embodiment, the support frame 7 comprises two anchors (anchoring means) attached on opposite sides of the stanchion 4 by one or more struts 10. The anchors, in the arrangement shown in FIGS. 1-2, 5 and 6, comprise sleeves 9, 9a, 9b, which are located such that one is upstream of the stanchion 4 and the other is downstream of the stanchion 4 (i.e. arranged generally along the third direction).

The location of the sleeve 9, 9a, 9b upstream of the stanchion 4 causes water flowing toward the TEC system 1 to initially flow around the sleeve 9, 9a, 9b before flowing past the stanchion 4. The sleeve 9, 9a, 9b downstream of the stanchion 4 serves to reduce the size of the wake caused by the TEC system 1. The sleeves 9, 9a, 9b and the stanchion 4 therefore effectively create a streamlined shape.

The sleeves 9, 9a, 9b are proportioned to fit over piles 11 that are embedded (for example, driven or drilled) in the seabed S. The sleeves 9, 9a, 9b may therefore be considered as anchors, holding the TEC support apparatus 2 to the piles 11, and therefore the seabed S. Attaching sleeves 9, 9a over piles 11 that are embedded in the seabed S may be termed a ‘female’ attachment.

Grout is inserted into the annulus between the sleeve 9, 9a, 9b and the pile 11 during installation to rigidly connect the sleeve 9, 9a, 9b and the pile 11 as a single, uniform whole (i.e. the sleeve 9, 9a, 9b and pile 11 are connected monolithically). Other means of connection, such as bolts, may be used instead of, or in addition to, the grout to connect the sleeve 9, 9a, 9b to the pile 11. The support frame 7 is attached to the lower end of the stanchion 4 to hold the TEC system 1 rigidly to the seabed S.

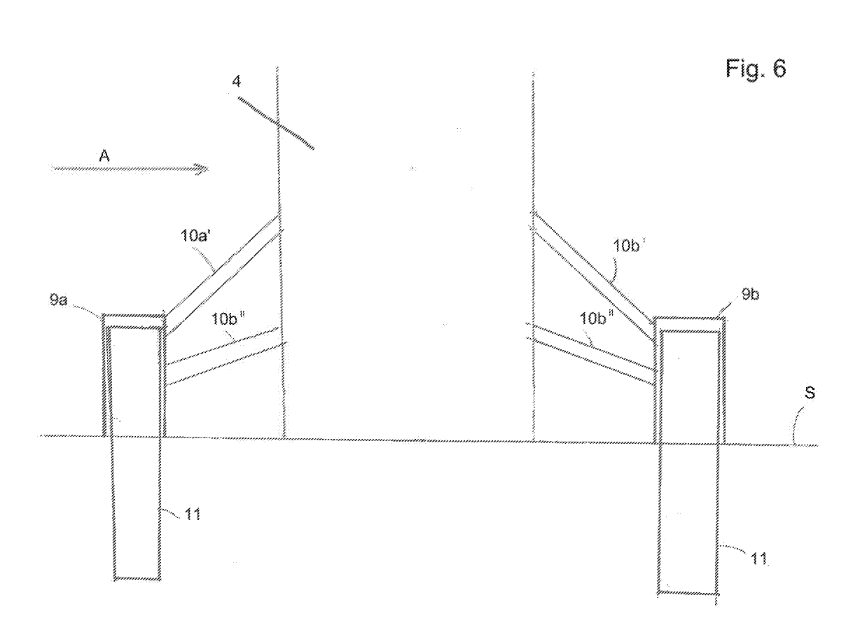

In FIG. 6, the two sleeves 9a, 9b are arranged in a bipedal, or ‘bipod’, arrangement with a first sleeve 9a attached to one side of the stanchion 4 and the second sleeve 9b attached to the opposite side of the stanchion 4. When the TEC support structure 14 is viewed from above, as in FIG. 5, the sleeves 9a, 9b are located along a line that passes through the smaller ends of the stanchion 4 (i.e. a line that is arranged along the lengthwise direction of the cross section of the streamlined section of the stanchion 4). Put another way, the bipedal support frame 7 extends further in a direction perpendicular to the cross arm 5 (i.e. the third direction) than in the direction parallel with the cross arm 5 (i.e. the second direction).

In FIG. 6, the sleeves 9a, 9b are shown with a circular cross section. It will be appreciated that other cross sections may be used for the sleeves 9a, 9b, such as a streamlined cross section as described in relation to the stanchion 4 or the cross arm 5, as long as it fits over the pile 11.

The two pile, or ‘bipedal’, support frame 7 discussed above is advantageous in that the bending moments in the predominant load direction (i.e. against the tidal flow) are reduced. The projected drag area of the TEC support apparatus 2 (i.e. the surface of the TEC support apparatus 2 ‘seen’ by the tidal flow) is also reduced. Further, the upper limit of the required pile diameter may be reduced; this therefore facilitates the use of existing pile solutions and associated drilling technologies.

The support frame 7 bears the forces due to the TEC system 1. In FIG. 6, for example, when the tidal flow is in the direction of arrow A, the TEC system 1 will pull against a first anchor 9a whilst pressing against a second anchor 9b. When the water flows in the opposite direction to arrow A, the TEC system 1 will pull against the second anchor 9b whilst pushing against the first anchor 9a. In both situations, it is not necessary for the stanchion 4 to touch the seabed S in order to provide support for the TEC system 1, and the load of the TEC system 1 can instead be carried by the anchors 9a, 9b as shown in FIG. 1, for example. The support frame 7 may therefore be adapted to raise the stanchion 4 off of the seabed S.

Accordingly, it is not necessary for the stanchion 4 to make contact with the seabed S. This can lead to manufacturing efficiencies as the length of the stanchion 4 can be reduced. Additionally, the seabed beneath the stanchion 4 will not have to be specifically prepared prior to deployment of the TEC system 1. This reduces the amount of time required for deployment.

The diameter of the sleeve 9, 9a, 9b must be greater than the diameter of the pile 11, and must allow space for the grout if used. The sleeves 9, 9a, 9b are preferably attached to the outside of the stanchion 4 (and therefore outside the footprint of the stanchion 4), although the sleeves 9, 9a, 9b can be located inside the footprint of the stanchion 4 when the stanchion 4 has an appropriate size and shape.

The sleeves 9, 9a, 9b are attached to the stanchion 4 by one or more struts 10, 10a, 10b, 10a′, 10b′ 10a″, 10b″, thereby providing a more stable base for the TEC system 1. FIG. 6 shows an aspect in which the two sleeves 9a, 9b are attached to the stanchion 4 with two struts 10a′, 10b′ 10a″, 10b″ (only the upper struts 10a′, 10b would be visible from above, as in FIG. 5). The lower strut 10a″, 10b″ is 20 degrees above horizontal to the sleeve 9a, 9b, and the upper strut 10a′, 10b′ is 60 degrees above horizontal to the sleeve 9a, 9b. The struts 10a′, 10b′ 10a″, 10b″ can be attached to the sleeves 9a, 9b at other angles. For example, the struts 10a′, 10b′ 10a″, 10b″ may extend from the sleeves 9a, 9b at an angle above horizontal and below vertical. In other words, the struts 10a′, 10b′ 10a″, 10b″ may extend from the sleeves 9a, 9b at between 0° and 90° above horizontal.

In a similar manner to the anchors 9a, 9b, water will flow around the struts 10a′, 10b′ 10a″, 10b″ before flowing past the stanchion 4. The struts 10a′, 10b′ 10a″, 10b″ downstream of the stanchion 4 serve to reduce the wake caused by the TEC system 1. Furthermore, by placing the struts 10a′, 10b′ 10a″, 10b″ at an angle other than horizontal, the profile of the struts 10a′, 10b′ 10a″, 10b″ ‘seen’ by the tidal flow will be generally elliptical if the struts 10a′, 10b′ 10a″, 10b″ have a circular cross section. This further aids the fluid dynamic efficiency of the TEC system 1.

The bipedal support frame 7 may be two separate anchors 9 and associated attachment means, and does not need to be formed as a single construction. For example, the bipedal support frame 7 in FIG. 5 comprises the anchors 9a, 9b and the struts 10a, 10b.

The use of sleeves 9, 9a, 9b and piles 11 provides an efficient way of anchoring the TEC system 1 to the seabed S. The piles 11 can be embedded in the seabed S at any time before the TEC system 1 is deployed. Accordingly, deployment may be scheduled for shorter windows of good weather, when risk to surface vessels (and any divers) is minimised.

### Tidal Energy Converter (TEC)

The TEC support system 1 described herein can be used to support many different types of TEC 3. FIGS. 1, 3, 7 and 8 show examples where the TEC 3 is a horizontal axis turbine.

The TEC 3 comprises a TEC nacelle 6, acting as a housing for an axle (not shown), a generator (not shown), and two or more blades 12. In FIGS. 1 and 3, three blades 12 are shown for example. The TEC nacelle 6 may be a streamlined shape, being generally tubular and narrowing toward either end. In the preferred embodiment, the streamlined shape continuously narrows, whereas in other embodiments, the streamlined shape may narrow in a step-wise manner. Water flowing over the blades 12 cause the blades 12 to rotate. In turn, the blades 12 rotate the generator to produce electricity.

### Deployment

A TEC system 1 as described herein is designed to be completely submerged when deployed. When deploying a TEC system 1 including horizontal axis turbines as TECs 3 with blades, however, the clearance between the blades 12 of the TEC 3 and the sea surface, and the clearance between the blades 12 and the seabed S must be taken into account. The clearance from the sea surface prevents the TEC 3 from being exposed to the so-called ‘splash zone’, where the air and sea make for a highly corrosive and dynamic environment, and passing vessels and other interaction with the sea surface. A clearance of approximately 5 m or more from the seabed and the sea surface is sufficient. The clearance from the seabed does not have to be the same as the clearance from the sea surface.

A TEC system 1 according to the present invention may be deployed as a complete unit, or deployed as a series of separate units. For example, the support frame 7 and stanchion 4 may be deployed first, followed by the cross arm 5. The TECs 3 may later be mounted to the cross arm 5.

### Modifications

Although the stanchion 4 in the preferred embodiment has a streamlined cross section over at least a part of its length, other cross sections are envisaged. For example, the stanchion 4 may have a circular cross section. This allows for ease of manufacturing in comparison to the preferred embodiment. Further, a circular cross section will provide additional strength against any unexpected current with a component perpendicular to the bi-directional current. Similarly, the cross arm 5 may have a circular cross section for ease of manufacture.

In some embodiments, a conventional mass damper may be applied to the cross arm 5 to reduce vibrations, save weight and reduce drag.

The preferred embodiment describes a bipedal support frame 7 including two anchors. In other embodiments, however, any number of anchors may be used with the support frame extending further in the third direction than in the second direction (i.e. the bipedal support frame 7 is streamlined). For example, each anchor of the preferred embodiment may be replaced with two smaller, closely spaced anchors.

The preferred embodiment uses sleeves 9 to anchor the support apparatus 2 to piles 11, which are embedded into the seabed S, in a ‘female’ attachment method. Other methods of anchoring the support apparatus 2 are also envisaged. For example, a ‘male’ attachment may be used in which sleeves are driven into the seabed S, with the anchors comprising piles placed into those sleeves. In this ‘male’ attachment, the piles may still be attached to the stanchion 4 by struts 10a′, 10b′ 10a″, 10b″, as described in relation to the ‘female’ attachment method.

In alternative examples, the support frame 7 may comprise ballast blocks in place of the sleeves and piles of the preferred arrangement if the TEC system 1. Such an alternative may be deployed in locations where embedding piles into the seabed S is difficult (for example, where the seabed S is particularly dense rock, or is too soft to readily support the TEC system 1).

In alternative embodiments, the TEC systems in a TEC array are deployed other than in a rectangular grid. For example, one row may be offset from the rows upstream and downstream of that one row such that the TEC systems in one column of the grid appear in every second row and TEC systems in the column adjacent to that one column do not appear in the same rows as the TEC systems in the one column.

In alternative embodiments, the TECs 3 may be mounted directly to the cross arm 5, which can then be attached to the stanchion 4 via a YDS. In these aspects, the YDS allows the cross arm 5, together with the TECs 3, to rotate thereby enabling the TECs 3 to point into the tidal flow. Advantageously, this arrangement reduces the risk of contact between the TECs 3 and the cross arm 5.

In alternative embodiments, the cross arm 5 is attached to the stanchion 4 via an arm so as to displace the cross-arm 5 from the stanchion 4 in the direction of tidal flow. In certain of these aspects, a single arm extends away from the stanchion 4 in the third direction. In certain other aspects, two or more arms may extend from the stanchion 4. Displacing the cross arm 5 from the stanchion 4 in the direction of tidal flow reduces drag, and also provides greater separation between the TECs 3 and the stanchion 4, which further reduces drag.

All these and any other variants which would be apparent to the reader are intended to be covered by the scope of the present application. Protection is hereby claimed for any and all novel subject matter and combinations thereof whether or not within the scope of the attached claims.

### REFERENCE NUMERALS

1 TEC system
2 TEC support apparatus
3 TEC
4 Vertical support member/Stanchion
5 Cross arm
6 TEC nacelle
7 Bipedal support frame
8 Support strut
9 Sleeve/Anchor
10 Support strut
11 Pile
12 Blade
13 Yaw drive system
14 Support Structure

1. A support structure for tidal enemy converters, the support system being for completely submerged deployment and comprising a single stanchion, a cross arm, and a support frame, wherein
the stanchion extends in a first direction,
the cross arm extends in a second direction perpendicular or substantially perpendicular to the first direction, is statically attached to the stanchion and is operable to support a plurality of tidal enemy converters; and
the support frame extends further in a third direction perpendicular or substantially perpendicular to the first and second directions, than in the second direction, is attached to the stanchion, and is operable to anchor the support system to a seabed.

2. A structure according to claim 1, wherein at least part of the length of the stanchion has a streamlined cross section, the streamlined cross section extending further in the third direction than in the second direction.

3. A structure according to claim 2, wherein the lengths of the streamlined cross section of the stanchion in the third direction and in the second direction are in the ratio 1.5-5:1.

4. A structure according to claim 1, wherein the stanchion has a circular cross-section.

5. A structure according to claim 1, further comprising two or more struts attached to and extending from the stanchion and attached to the cross arm.

6. A structure according to claim 1, wherein the cross arm has a streamlined cross section, which extends further in the third direction than in the first direction.

7. A structure according to claim 1, wherein the stanchion and support frame form a streamlined support apparatus.

8. A structure according to claim 1, wherein the support frame is a bipedal support frame comprising two anchors for use in attaching the support structure to the seabed.

9. A structure according to claim 8, further comprising one or more struts for each anchor, the struts being operable to attach the anchors to the stanchion.

10. A structure according to claim 9 wherein one or more of the struts attaching an anchors to the stanchion extends from the anchors at between 0° and 90° above horizontal.

11. A structure according to claim 9, wherein the struts have a circular cross section.

12. A support structure for tidal enemy converters comprising a bipedal support frame comprising two anchors for use in attaching the support structure to a seabed, wherein the support structure is a static support structure.

13. A structure according to claim 12, wherein an anchor comprises a sleeve for coupling to a pile embedded in the seabed.

14. A structure according to claim 12, wherein an anchor comprises a pile for coupling to a sleeve embedded in the seabed.

15. A structure according to claim 12, wherein the bipedal support frame maintains the stanchion raised above the seabed.

16. A structure according to claim 1, wherein the third direction is parallel to the normal flow direction of a tide, the second direction is transverse to the normal flow direction of a tide and the first direction is vertical.

17. (canceled)

18. A tidal enemy converter array mounted on a seabed comprising a plurality of support structures for tidal enemy converters, wherein the support structures include a single stanchion, extending in a first direction, and a cross arm, extending in a second direction perpendicular, or substantially perpendicular, to the first direction, statically attached to the stanchion, and wherein the support structures have a streamlined component extending further in a third direction, perpendicular or substantially perpendicular to the first and second direction, than in the second direction and being disposed in an arrangement with regular spacing between support structures in the second direction.

19. An array of claim 18, wherein the arrangement comprises a plurality of rows.

20. An array according to claim 18 wherein the third direction is parallel to the normal flow direction of a tide, the second direction is transverse to the normal flow direction of a tide and the first direction is vertical.

21. An array according to claim 18 wherein each support structure includes a streamlined support apparatus as the streamlined component, wherein the streamlined support apparatus comprises at least the single stanchion.

22. An array according to claim 18, wherein the support structure includes a bipedal support frame operable to anchor the support structure to the seabed.

23. (canceled)

24. (canceled)

25. (canceled)

26. A tidal energy converter system, comprising:
a support system for completely submerged deployment and comprising a single stanchion, a cross arm, and a support frame; and
a plurality of tidal energy converters supported on the cross arm;
wherein the stanchion extends in a first direction, the cross arm extends in a second direction perpendicular or substantially perpendicular to the first direction and is statically attached to the stanchion, and the support frame extends further in a third direction perpendicular or substantially perpendicular to the first and second directions, than in the second direction, is attached to the stanchion, and is operable to anchor the support system to a seabed.
